(19) United States
(12) Patent Application Publication
(10) Pub. No.: US 2026/0145363 A1
(43) Pub. Date: May 28, 2026

(54) APPARATUS AND METHOD FOR ARTIFICIALLY AGEING BLOCKS

(71) Applicant: Baustoffwerke Gebhart & Soehne GmbH & Co. KG, Lachen (DE)

(72) Inventor: Hans GEBHART, Lachen (DE)

(21) Appl. No.: 19/121,556

(22) PCT Filed: Oct. 16, 2023
(86) PCT No.: PCT/EP2023/078714

§ 371 Date: Apr. 16, 2025

(30) Foreign Application Priority Data
Oct. 18, 2022 (DE) 10 2022 127 281.8

(51) Int. Cl. B28D 1/00; B28D 1/28; B28D 7/02

(52) U.S. Cl. CPC B28D 1/006; B28D 1/28; B28D 7/02

(57) ABSTRACT

The invention relates to an apparatus for artificially ageing blocks, in particular concrete blocks, vitrified bricks and natural stones, with the following features: an underlying surface (2), on which the blocks (1) can be placed in such a way that the surface thereof to be worked (1a) and the adjoining edges (1b) are exposed; a retaining device (4), arranged above the underlying surface (2) and having a plurality of retaining elements (6), on which, for the purpose of working the surfaces (1a) and the adjoining edges (1b) of the blocks (1), the distressing bodies (3) are movably fastened in such a way that the fastening allows a movement of the distressing bodies (3) within a defined range relative to the surface (1a) of the blocks (1); a vibration device (5), to make the underlying surface (2) on which the blocks (1) are resting vibrate in order for the blocks (1) resting on the underlying surface (2) and the distressing bodies (3) to be set in motion in relation to one another in such a way that the distressing bodies (3) act on the surface (1a) and the adjoining edges (1b) of the blocks. The apparatus has at least a first oscillation device (9) and a second oscillation device (10). The oscillation devices (9, 10) each have at least one push rod (11), the one end of which is connected to the retaining device (4) and the other end of which is fixed to a suspension device (12) arranged above the retaining device (4).

The present application claims the priority of German patent application No. 10 2022 127 281.8, the content of which is incorporated herein by reference in its entirety.

The invention relates to an apparatus for artificially ageing blocks, in particular concrete blocks, vitrified bricks and natural stones according to the preamble of claim 1. The present invention also relates to a method for artificially ageing blocks according to the preamble of claim 21.

A generic apparatus for ageing is known from EP 1 893 391B1.

Stones, for example covering elements, façade elements, sand-lime blocks, concrete blocks, bricks or vitrified bricks, natural stones and the like, are often subjected to post-treatment, regardless of their material properties, in order to lose their artificial appearance.

Freshly manufactured, set concrete blocks, in particular concrete paving blocks, are frequently subjected to this type of post-treatment, during which the surfaces and/or edges are struck or broken in order to adapt the appearance to natural stones. For this purpose, large numbers of concrete blocks are placed in a rotary drum and “rumbled” there, wherein the surfaces and edges of the blocks strike each other and the blocks treated in this way leave the drum in an “aged” state. Such an apparatus is known from DE-OS 29 22 393.

When concrete blocks are treated in a rotary drum, surfaces and edges are also treated that are not even visible in a pavement, e.g., when using aged blocks. This is an unnecessary waste of energy and time. Furthermore, it is necessary to place the treated concrete blocks leaving the rotary drum in a regular arrangement on a pallet for shipping, which requires an unreasonably high amount of work and time.

In the prior art, sorting systems are known for sorting blocks, which align the blocks accordingly and arrange them on pallets. Such sorting systems incur high acquisition and operating costs and also require a corresponding amount of space.

DE 36 21 276 C2 discloses a method in which concrete blocks are applied in a single layer in a regular arrangement on a panel-shaped base. The exposed surface and the adjacent exposed edges or substantially only the edges of the concrete blocks are then irregularly struck by means of a vibrating tapping or striking device.

This process eliminates the need for a subsequent sorting device, as the production position is not changed. Before being worked by the tapping or striking devices, the blocks are pushed together and aligned on the plate-shaped base so that the blocks lie close together and there are no gaps between them. The striking tools of the striking device are arranged on a movable carriage, which guides them over the surfaces of the blocks so that the free surfaces and the upper edges of the blocks are struck by the striking tools.

A disadvantage of this process, however, is that the blocks aged in this way look artificially processed and not naturally aged. The application of the process according to DE 36 21 276 C2 does not result in an ideal edge fracture of the blocks, as is produced by the rumbling of the blocks in a rotary drum.

DE 20 2004 020 206 discloses an apparatus for artificially ageing blocks, in which the blocks-preferably in their production position-are placed on a base so that the surfaces to be worked and the adjacent edges of the blocks are exposed. A magnet is then used to apply freely movable metal distressing bodies to the surface to be worked. A vibration device is used to vibrate the base on which the blocks are placed. This causes the blocks and the distressing bodies to move in relation to each other in such a way that the distressing bodies act on the surfaces and the exposed edges of the blocks.

The apparatus known from DE 20 2004 020 206 enables fast and effective ageing of the top surface of the blocks and the adjacent exposed edges. The distressing bodies hit the surfaces of the blocks randomly and thus strike them irregularly, creating an appearance that corresponds to that of a naturally aged stone.

After the ageing process, the metal distressing bodies are lifted off the surface of the blocks again by the magnet-by bringing it closer to the blocks. The block layer can be removed and a new block layer added. A disadvantage is that the magnet to be used is very expensive. A further disadvantage is that the magnet causes corresponding non-productive times when setting down and picking up the distressing bodies, which leads to longer cycle times.

A particularly advantageous apparatus and method for artificially ageing blocks is known from the generic document EP 1 893 391B1. The generic document has further developed the method and the apparatus according to DE 20 2004 020 206. It is provided that a retaining device with a plurality of retaining elements is arranged above the base on which the blocks are placed, to which distressing bodies are movably attached for working the surfaces and the adjacent edges of the blocks in such a way that the attachment allows a movement of the distressing bodies within a defined range relative to the surface of the blocks. As in DE 20 2004 020 206, a vibration device is provided to set the base on which the blocks rest in motion in order to set the blocks resting on the base and the distressing bodies in motion in relation to one another in such a way that the distressing bodies act on the surface and the adjacent edges of the blocks, so that the blocks are artificially aged. In order to improve the ageing process or to achieve a naturally aged appearance of the blocks, it is proposed in the generic document that the retaining elements oscillate during the impacting action of the striking bodies on the blocks in order to support an irregular striking of the blocks by the striking bodies. An oscillating movement of the retaining elements is provided in such a way that the retaining elements are moved back and forth axially. An eccentric bearing or a randomly controlled pneumatic cylinder is proposed in order to achieve an oscillating movement of the retaining elements.

The apparatus and method disclosed in the generic document enable the blocks to be aged quickly and inexpensively in such a way that the blocks are given an appearance reminiscent of or close to a naturally aged stone.

The present invention addresses the problem of further improving the apparatus known from the generic document and the method known from the generic document for artificially ageing blocks, in particular to develop an apparatus and a method which enables particularly cost-effective and rapid ageing of blocks, so that the blocks are given an appearance which corresponds as closely as possible to that of a naturally aged stone.

According to the invention, this object is achieved by the apparatus according to claim 1.

According to the invention, this object is also achieved by the method according to claim 21.

The apparatus according to the invention for artificially ageing blocks, in particular concrete blocks, vitrified bricks and natural stones, has an underlying surface on which the blocks can be placed in such a way that their surface to be worked and the adjacent edges are exposed. Furthermore, the apparatus according to the invention has a retaining device arranged above the underlying surface with a plurality of retaining elements, to which distressing bodies are movably fastened for working the surfaces and the adjacent edges of the blocks in such a way that the fastening allows a movement of the distressing bodies within a defined range relative to the surface of the blocks. The apparatus according to the invention further comprises a vibration device for vibrating the underlying surface on which the blocks rest in order to set the blocks resting on the underlying surface and the distressing bodies in motion in relation to one another in such a way that the distressing bodies act on the surface and the adjacent edges of the blocks.

According to the invention, at least one first oscillation device and one second oscillation device are provided, wherein the oscillation devices each have at least one push rod, one end of which is connected to the retaining device and the other end of which is fixed to a suspension device arranged above the retaining device, wherein the first oscillation device effects a first oscillating movement of the retaining device along a first oscillation axis and the second oscillation device effects a second oscillating movement of the retaining device along a second oscillation axis, wherein the oscillation axes extend at an angle of 90° to one another, and wherein at least one of the oscillation devices additionally alternately moves the retaining device away from the surface of the blocks and brings it closer again.

It has been shown that by providing a first oscillation device, which generates a first oscillation movement along a first oscillation axis, and a second oscillation device, which generates a second oscillation movement along a second oscillation axis, a particularly advantageous ageing pattern can be generated for the blocks and the ageing process is thereby also accelerated. Oscillation along two oscillation axes running at an angle of 90° to each other has proved to be even more advantageous compared to the apparatus and method according to the generic document, in which oscillation is proposed in such a way that the retaining elements are moved axially back and forth.

According to the invention, it is additionally provided that at least one of the oscillation devices additionally alternately removes the retaining device from the surface of the blocks and brings it closer to the surface of the blocks again. The (slight) lifting movement that the retaining device thus performs results in the striking bodies fixed to the retaining device also performing a (slight) lifting movement. The distressing bodies are thus set in motion not only due to the vibration of the blocks that strike the distressing bodies from below (caused by the fact that the underlying surface on which the blocks rest vibrates), but also due to the fact that the retaining device on which the distressing bodies are arranged is itself alternately raised and lowered.

It has been shown that this stroke movement, in conjunction with the specific oscillation movement along the first and second oscillation axes, achieves a particularly advantageous irregularity in the impact of the striking bodies on the surface and edges of the blocks.

The method and apparatus according to the invention can be used to produce an ageing pattern that corresponds to that of the rotary drum without having to accept the disadvantages of the rotary drum.

It has proven to be particularly advantageous if both oscillation devices are designed in such a way that they alternately remove the retaining device from the surface of the blocks and bring it closer again.

It should be noted that the definition according to the invention, namely that the first oscillation device causes a first oscillating movement of the retaining device along the first oscillation axis, does not exclude the possibility that the first oscillation device additionally generates an alternating movement such that the retaining device is moved away from the surface of the blocks and brought closer to it again. The movements can overlap or be triggered by a corresponding movement of the lifting rod.

The same applies to the second oscillation device.

It is advantageous if the first and second oscillation devices are arranged or act on the retaining device in such a way that the first oscillation axis along which the retaining device oscillates runs parallel to the feed direction with which the blocks are transported through the apparatus or through the ageing area of the apparatus. The second oscillation axis along which the retaining device is moved due to the second oscillation device preferably runs transversely or orthogonally to the feed direction of the blocks.

In the context of the definition of the first oscillation movement, a movement along the first oscillation axis is to be understood in relation to the oscillation of the retaining direction; it can therefore preferably be a movement both in and against the feed direction of the blocks, since an oscillation ultimately leads to a back and forth movement. Accordingly, the second oscillation movement is also to be understood as a back and forth movement along the second oscillation axis, thus preferably a back and forth movement orthogonal to the feed direction of the blocks.

The retaining device, to which the distressing bodies are attached, will generally have the shape of a rec-tangle when viewed from above, in particular with two longitudinal sides and two transverse sides, which together form a frame. The retaining device preferably has a longitudinal axis that runs parallel to the feed direction of the blocks and a transverse axis that runs orthogonal to the feed direction of the blocks. The retaining elements, on which the distressing bodies are suspended, preferably run parallel to the transverse axis of the retaining device.

The first oscillation axis thus preferably runs parallel to the feed direction or parallel to a longitudinal axis of the apparatus or parallel to a longitudinal axis of the retaining device.

The second oscillation axis thus preferably runs transversely or orthogonally to the feed direction and parallel to the plane in which the distressing bodies or the blocks to be aged are arranged. Preferably, the second oscillation axis runs parallel to a transverse axis of the apparatus or parallel to a transverse axis of the retaining device or parallel to the retaining elements of the retaining device.

According to the invention, it may be provided that the first oscillation axis and the second oscillation axis extend substantially in a plane which is plane-parallel to the plane in which the distressing bodies are arranged.

This results in a particularly advantageous effect of the distressing bodies on the surface and the adjacent edges of the blocks. The two oscillation axes preferably also run in a plane which is plane-parallel to a plane which spans the retaining device or plane-parallel to a plane in which the distressing bodies are arranged, in particular plane-parallel to a plane which is formed by the ends of the distressing bodies facing the blocks.

According to the invention, it may further be provided that the push rod of the first oscillation device and/or the push rod of the second oscillation device is fixed eccentrically to a drive device of the suspension device.

A push rod that is fixed eccentrically to a drive device has proven to be particularly suitable for transmitting the oscillating movements, especially due to the high stress on the components during operation. The drive unit is part of the suspension device and is preferably detachably connected to it.

It is advantageous if the first oscillation device has two push rods, each of which is fixed eccentrically to a common drive device.

It has proven to be particularly suitable for transmitting the oscillating movement along the first oscillation axis if two push rods are provided, which are fixed to a common drive device. In principle, it would be possible to use two (or more) push rods, each of which could also be attached to its own drive unit. However, it has proven to be particularly suitable for the process if two push rods are fixed to a common drive device.

It is advantageous if a shaft of the drive device extends transversely to the feed direction of the blocks, wherein a control disk is fixed at each end of the shaft of the drive device, to which one of the two push rods is eccentrically fixed.

This design has proven to be particularly suitable for transmitting the first oscillating movement to the retaining device. The shaft of the drive device preferably runs parallel to the second oscillation axis.

It is advantageous if the end of the push rod connected to the retaining device and intended for transmitting the first oscillating movement is fixed to a longitudinal side of the retaining device, preferably centrally on the longitudinal side of the retaining device in relation to the longitudinal axis of the longitudinal side.

It has proven to be particularly suitable to fix the push rod, which is used to transmit the first oscillating movement, to one longitudinal side of the retaining device. It is particularly advantageous if the first oscillation device has two push rods and each of the push rods is fixed to one of the two longitudinal sides of the retaining device. Preferably, the ends of the respective push rod are fixed to the respective longitudinal sides of the retaining device in such a way that a (imaginary) straight line connecting the two ends runs parallel to the second oscillation axis. Preferably, the ends of the two push rods, which are fixed to the respective longitudinal sides of the retaining device, are arranged in mirror image.

According to the invention, it may further be provided that the second oscillation device comprises a push rod extending transversely to the direction of advancement of the blocks, wherein the end of the push rod connected to the retaining device is fixed to a fastening element of the retaining device which is located above a position at which the push rod or the push rods of the first oscillation device are fixed to the retaining device.

Tests have shown that this type of arrangement enables a particularly advantageous oscillating movement to be achieved both along the first oscillation axis and along the second oscillation axis. Furthermore, the arrangement has proven to be particularly robust.

The push rods are preferably connected to the retaining device and/or the suspension device or the drive device via a joint so that the oscillation can be compensated without damaging the fastening elements.

According to the invention, it may further be provided that a suction device is provided which has at least one suction unit with a plurality of suction elements which are positioned in spaces between the distressing bodies, in particular in spaces which are located in front of and/or behind the distressing bodies in the direction of advance of the blocks.

It has proven to be particularly suitable if a suction device is provided of which the suction elements are positioned in spaces between the distressing bodies. It has proved to be particularly suitable if the suction elements are positioned in intermediate spaces which, viewed in the direction of advance of the blocks, are present in front of and/or behind the distressing bodies.

It should be noted that a suction device has also proved to be particularly suitable independently of the oscillation device, in particular in order to minimize exposure to dust. The applicant therefore reserves the right to file a divisional application claiming protection for a suction device independently of the oscillation device.

In particular, the divisional application can be used to claim protection for an apparatus and a corresponding method for the artificial aging of blocks, as shown below.

An apparatus for artificially ageing blocks, in particular concrete blocks, vitrified bricks and natural stones, having the following features: an underlying surface on which the blocks can be placed in such a way that their surface to be worked and the adjoining edges are exposed; a retaining device arranged above the underlying surface and having a plurality of retaining elements to which distressing bodies are movably fastened for working the surfaces and the adjoining edges of the blocks in such a way that the fastening allows a movement of the distressing bodies within a defined range relative to the surface of the blocks; a vibrating device for vibrating the underlying surface on which the blocks rest in order to set the blocks resting on the underlying surface and the distressing bodies in motion in relation to one another in such a way that the distressing bodies act on the surface and the adjacent edges of the blocks, wherein a suction device is provided which has at least one suction unit with a plurality of suction elements which are positioned in intermediate spaces between the distressing bodies, in particular in intermediate spaces which are located in front of and/or behind the distressing bodies in the direction of advance of the blocks.

Advantageous embodiments and divisional applications result from the further features of the present application, in particular the further features of the suction device, but also from all other features, in particular also the oscillation device.

The following and preceding explanations are to be understood in such a way that they can refer to the present invention as well as to the second invention “suction device” and the third invention “flexible suspension elements”.

It is advantageous if the retaining elements are designed as retaining rods which are arranged one behind the other in the feed direction of the blocks and each extend transversely or orthogonally to the feed direction of the blocks, wherein a plurality of distressing bodies are arranged, preferably suspended, on each retaining rod.

It has proven to be particularly suitable if the retaining elements are designed as retaining rods. The retaining rods can preferably have a circular cross-section, and preferably the retaining rods can also be designed as tubes, i.e., with an annular cross-section. In the present case, the term “rods” includes both a solid material and a tube.

The retaining device with the retaining elements, which are preferably designed as retaining rods, forms a plane within which the distressing bodies can be arranged, preferably suspended. Preferably, the retaining device has twenty to forty, in particular twenty-two to thirty-five, particularly preferably twenty-five to thirty, retaining rods, on each of which a row of distressing bodies is arranged, preferably suspended.

Preferably, the apparatus according to the invention has two suction units. It may be provided that one suction unit suctions the first half of the apparatus lying at the front in the feed direction of the blocks and the second suction unit suctions the second half of the apparatus lying at the rear in the feed direction, i.e., that the first suction unit is assigned to the first half of the plurality of holding bars and the second suction unit is assigned to the second half of the plurality of holding bars.

It is advantageous if the suction unit has a plurality of suction arms which extend parallel to the support rods and to each of which a plurality of the suction elements are connected, wherein the suction elements extend from the respective suction arm into at least part of the intermediate spaces which are formed between two adjacent rows of distressing bodies arranged on the support rods.

It has proved to be particularly advantageous to design the suction units with a plurality of suction arms extending parallel to the support rods. The suction arms preferably extend in front of or behind one of the retaining rods, viewed in the direction of advance of the blocks, in such a way that suction elements from the suction arms preferably orthogonally in the direction of the blocks penetrate into the spaces between two rows of distressing bodies, each of which is arranged on a retaining rod.

The suction elements are preferably designed in such a way that one suction opening of the suction elements is directed towards the surface of the blocks. Preferably, the suction elements end at such a distance in front of the surface of the blocks that they are not struck by the vibrating blocks, i.e., that the striking bodies project further down towards the surface of the blocks than the ends of the suction elements.

Within the scope of the invention, it may be provided that at least one suction element is arranged in each intermediate space between two retaining rods. Preferably, several suction elements are positioned in each of the intermediate spaces, preferably in such a way that these cover the length of the intermediate space, i.e., its extension, transversely to the feed direction of the blocks as uniformly as possible. It has proven to be particularly suitable if a suction arm runs above the intermediate space in which the suction elements are to be positioned. Preferably, three to nine, preferably four to eight, in particular five to seven, suction arms can be arranged on each suction arm. The suction arms are preferably arranged in a line that is preferably orthogonal to the direction in which the blocks are fed.

In the context of the invention, it has been found to be suitable if suction elements are not arranged in every intermediate space between two retaining rods. However, it has been found to be advantageous if a suction arm is positioned adjacent to a plurality, preferably adjacent to each retaining rod, preferably either before or after a retaining rod. This allows the number of suction elements required to be reduced accordingly. It has also been shown that it is not necessary for suction elements to be arranged adjacent to the first rows of distressing bodies, i.e., the rows of distressing bodies that the blocks pass through first when passing through the ageing area. Within the scope of the invention, it can thus be provided that no suction elements are positioned adjacent to at least the first two rows of distressing bodies.

Within the scope of the invention, it may be provided that at least one suction element is positioned adjacent to a plurality of the retaining rods in an intermediate space between two retaining rods.

It is advantageous if each of the suction units has three to nine, preferably four to eight, in particular five or six, suction arms, and wherein a central suction nozzle is provided, to which the suction arms are preferably connected by means of a central supply channel extending in the direction of feed of the blocks.

A design of the suction units such that they have the aforementioned number of suction arms and a central suction nozzle is provided in each case, which preferably extends upwards from the suction units in the direction of the suspension device, has proven to be particularly suitable. The suction nozzle is preferably arranged substantially in the center, relative to the plane spanned by the respective suction unit.

According to the invention, it may further be provided that the retaining device is suspended from the suspension device by a plurality of flexible suspension elements.

In the context of the invention, it has been shown that it is particularly advantageous with regard to oscillation, but also with regard to the most irregular possible impact of the distressing bodies on the surfaces and edges of the blocks, if the retaining device is suspended from the suspension device with several flexible suspension elements.

Flexible suspension elements are understood to mean that the suspension elements enable an oscillating movement of the retaining device in a horizontal plane and that a lifting movement of the retaining device is also possible or is not limited by the flexible suspension elements. Suspension using rigid rods, even if they have damping, means that oscillation of the retaining device, and in particular also lifting of the retaining device due to the distressing bodies or a desired lifting movement of the retaining device, is transmitted directly to the suspension device, which is not desirable in the present case, particularly with regard to the durability of the apparatus. It is also desirable that the retaining device can move within certain limits.

It should be noted that the use of flexible suspension elements to suspend the retaining device from the suspension device also offers particular advantages independently of the oscillation device or the suction device. The applicant therefore reserves the right to file a divisional application claiming protection for the flexible suspension elements independently of the oscillation device or the suction device.

The divisional application can be used to claim protection for an apparatus for the artificial aging of blocks, as shown below.

An apparatus for artificially ageing blocks, in particular concrete blocks, vitrified bricks and natural stones, having the following features: an underlying surface on which the blocks can be placed in such a way that their surface to be worked and the adjoining edges are exposed; a retaining device arranged above the underlying surface and having a plurality of retaining elements to which distressing bodies are movably fastened for working the surfaces and the adjoining edges of the blocks in such a way that the fastening allows a movement of the distressing bodies within a defined range relative to the surface of the blocks; a vibrating device for vibrating the underlying surface on which the blocks rest in order to set the blocks resting on the underlying surface and the distressing bodies in motion in relation to one another in such a way that the distressing bodies act on the surface and the adjacent edges of the blocks, wherein the retaining device is suspended from the suspension device by a plurality of flexible suspension elements.

Advantageous embodiments result for this divisional application from the further features of the present application, in particular the further features of the flexible suspension elements, but also from all other features, in particular also the oscillation device and the suction device.

The following and preceding explanations are to be understood in such a way that they can relate both to the present invention and to the third invention “flexible suspension elements”.

According to the invention, it may further be provided that the retaining device is suspended from the suspension device by means of at least four, preferably six or eight, flexible suspension elements.

It has proven to be particularly advantageous if the retaining device is suspended from the suspension device with the aid of six or eight flexible suspension elements. It is preferable that the flexible suspension elements are each attached to the two longitudinal sides of the retaining device and correspondingly above the retaining device on the suspension device.

It is advantageous if the flexible suspension elements are chains, ropes or straps.

It has proven to be particularly suitable if the flexible suspension elements are designed as chains, in particular with chain links made of metal, especially steel.

It is advantageous if the suspension device is height-adjustable relative to a support frame of the apparatus.

By adjusting the height of the suspension device relative to the supporting frame or the frame of the apparatus, the distance between the lower end of the distressing bodies and the underlying surface on which the blocks rest can be easily adjusted so that different heights of the blocks can be accommodated. This also makes it possible to influence the strength of the ageing, i.e., the strength of the distressing bodies'effect on the blocks.

According to the invention, it may further be provided that at least two, preferably four, height adjustment units are provided, which connect the suspension device to an upper frame part of the support frame present above the suspension device in such a way that the suspension device is height-adjustable by the height adjustment units, wherein the suspension device has guide elements, in particular guide rollers, which bear against vertical frame parts of the support frame in order to guide the suspension device during the height adjustment.

Height adjustment using height adjustment units, preferably four height adjustment units, has proven to be particularly suitable. These can preferably be spindle drives that can be operated manually or electrically.

It has also proved to be advantageous if the suspension device has rollers which can roll on vertical frame parts of the support frame when the suspension device is adjusted in height, so that the suspension device can be adjusted in a guided manner. Preferably, the apparatus according to the invention has a supporting frame with four vertical frame parts or supports, wherein the suspension device has a corresponding number of guide rollers, so that preferably each corner of the suspension device rests against the respectively assigned vertical frame part with a guide roller or can roll off there.

According to the invention, it may further be provided that a brushing device is provided which extends transversely to the direction in which the blocks are fed and which is positioned in such a way that the blocks pass through the brushing device after being subjected to the distressing bodies.

It has proved to be particularly advantageous if a brushing device is provided which extends transversely to the feed direction of the blocks and which has a length which corresponds at least to the width of a layer of blocks to be aged, i.e., the extension of a row of blocks transversely to the feed direction.

It has been shown that it is advantageous if the brushing device is arranged at the end of the apparatus, i.e., at the end at which the blocks are conveyed out of the ageing area.

The brushing device can be set up to clean and/or smooth the surface of the blocks and/or produce a surface shine.

It is advantageous if the brushing device has a brush rotating about a longitudinal axis, wherein the longitudinal axis of the brush extends transversely to the feed direction, wherein the brush is height-adjustable and arranged in such a way that the brush brushes the surface of the blocks.

By designing the brushing device in such a way that it has a brush that rotates around a longitudinal axis, for example a roller similar to those used in washing systems, but preferably with correspondingly hard bristles, it is possible to achieve particularly good cleaning of the surface and edges of rock residues and dust. Preferably, the entire brushing device or even just the brush is height-adjustable in such a way that different heights of the blocks can be accommodated and/or that wear of the brush, in particular its bristles, can be taken into account.

It is advantageous if the brushing device has a suction system.

The design of the brushing device with an additional suction unit, which preferably has a central suction connection, has proven to be particularly suitable.

It is advantageous if the brushing device has a swivel-out device that causes the brushing device to swivel out if the blocks fed in are higher than expected or if a predefined height is exceeded, e.g., if a block has been placed. The swivel-out device is preferably combined with an emergency shutdown, which stops the apparatus in this case.

According to the invention, it may further be provided that the distressing bodies, in order to suspend them from the retaining elements, in particular the retaining rods, have a recess, wherein the recess extends from an upper end of the distressing body in the longitudinal direction to a lower end facing the blocks to be worked, wherein the recess extends over at least 50% of the length of the distressing body, and wherein the recess has an access opening in the region of the lower third of a rear wall of the distressing body in order to insert the retaining elements, in particular the retaining rods.

It has proven to be particularly suitable if the distressing body has a comparatively long recess extending in the longitudinal direction of the distressing body, which preferably ends shortly before the upper end of the distressing body. It is preferable for an access opening to be formed in the lower third of the rear wall of the distressing body so that the distressing body can be threaded into the retaining elements, in particular the retaining rods. This design ensures that the distressing bodies can perform a comparatively large stroke without having to worry about the distressing bodies being unhooked from the retaining rod. In contrast to the prior art, in which the distressing bodies were provided with a slot, a design of the distressing bodies with a recess and an access opening, in particular as shown above, offers considerable advantages. On the one hand, the distressing bodies can be connected more easily to the retaining rods, namely through the access opening. On the other hand, in contrast to a slot, the stroke movement of the distressing bodies is substantially not limited, in particular if the recess extends over at least 50% of the length of the distressing body, i.e., its extension between the upper end of the distressing body, to which it is attached to one of the support rods, and the lower end of the distressing body, which acts on the surface and the edges of the blocks.

The recess in the distressing body is preferably designed such that the recess has a width (extension be-tween the front wall and the rear wall of the distressing body or in the direction of advance of the blocks) which is greater than the diameter of the retaining rod or of the retaining element in general, so that the distressing body can be moved relative to the retaining rod in the direction of advance and against the direction of advance of the blocks. Preferably, the recess has a width which is at least 10 % greater than the diameter of the retaining rod, preferably 20 % greater. Preferably, the width of the recess is 20 % to 40 % greater than the diameter of the retaining rod.

The present invention also relates to an advantageous method for artificially aging blocks as specified in claim 21.

In the method according to the invention for artificially ageing blocks, in particular concrete blocks, bricks, vitrified bricks and natural stones, it is provided that the blocks are placed on an underlying surface in such a way that the surface of the blocks to be worked and the adjacent edges are exposed, after which the surface of the blocks to be worked is brought into contact with a plurality of distressing bodies, which are each movable within a defined range relative to the surface of the blocks by means of a movable attachment to a retaining device arranged above the blocks, and after which the blocks are set in motion by a vibration of the underlying surface in such a way that the distressing bodies act on the surface and the adjacent edges of the blocks.

According to the invention, it is provided that the retaining device is moved oscillatingly in the direction of advance of the blocks and transversely to the direction of advance of the blocks while the distressing bodies are acting on the blocks and is additionally alternately removed from the surface of the blocks and brought closer again.

With the aid of the method according to the invention, a particularly advantageous ageing pattern can be produced on the blocks. This is due to the fact that the retaining device oscillates not only in one direction, but in two directions and, in addition, the retaining device is removed from the surface of the blocks and brought closer again. It may be sufficient if the ageing device is removed or raised by 0.5 cm to 10 cm, preferably 1 cm to 5 cm, in particular 1 cm to 3 cm, from the surface of the blocks and then moved closer again.

The oscillating movement and the alternating lifting of the retaining device can preferably be generated by two oscillation devices of which the direction of action is offset by 90° to each other.

According to the invention, it can be provided that the retaining device is suspended via flexible suspension elements, in particular chains, from a suspension device located above the retaining device.

Furthermore, according to the invention, it can be provided that, for the oscillating and alternating movement of the retaining device, push rods are provided, one end of which is fixed to the retaining device and the other end of which is fixed eccentrically to control disks of drive devices, wherein the drive devices are designed as part of the suspension device.

Preferably, the drive units are detachably connected to the suspension device.

Furthermore, according to the invention, it can be provided that the dust produced by the distressing bodies acting on the surface and the adjacent edges of the blocks is suctioned by a suction device which has a plurality of suction elements which are positioned in spaces between the distressing bodies, in particular in the spaces which are located in front of and/or behind the impact heads in the feed direction, and of which the suction openings are aligned in the direction of the surface of the blocks.

It is also advantageous if the surface of the blocks is brushed and/or smoothed and/or given a surface shine and preferably also vacuumed after the distressing bodies have acted on the surface and the adjacent edges of the blocks.

The apparatus according to the invention and the method according to the invention are particularly suitable if the blocks to be aged are transported through the ageing area, i.e., below the distressing bodies, with the aid of a conveyor device, in particular a conveyor belt. Alternatively, a feed rod can also be provided, for example. The conveyor device can push the blocks to be aged continuously or discontinuously underneath the movably mounted distressing bodies.

Continuous ageing also refers to an interval in which the blocks are pushed underneath the distressing bodies with short interruptions of e.g., 3 to 15 seconds. The distressing bodies have an ageing effect on the blocks due to the vibration of the blocks. As already described, the movable and flexible attachment of the distressing bodies ensures that the blocks are struck unevenly and also prevents the distressing bodies from moving with the blocks. The distressing bodies age the blocks that are located within the area available to them.

The range can be selected, for example, depending on the number of distressing bodies, the number of blocks and the throughput speed.

It has been found that even a relatively small area within which the distressing bodies can move on the surface of the blocks is sufficient. This prevents the distressing bodies from penetrating into the space between two blocks (due to excessive mobility) and possibly jamming there.

The ageing effect can be varied by the number of rows of distressing bodies below which the blocks have to pass under the impact of the distressing bodies. Furthermore, the strength of the ageing is determined by the throughput speed and the vibrations introduced.

By selecting a suitable number of rows of distressing bodies, the apparatus according to the invention can be easily integrated into the ongoing production process of blocks without this leading to a reduction in cycle time. The blocks can pass through the apparatus according to the invention at the desired speed, wherein the desired ageing effect is achieved by the number of rows of distressing bodies. Preferably, the distressing bodies of a row can each be arranged offset to an upstream or downstream row of distressing bodies, so that the surfaces of the blocks can be worked evenly. In principle, an unevenly aged image should be created, but this is achieved automatically by the movable attachment of the distressing bodies. A system-related (permanent) accumulation of block impacts within a certain area can be further reduced by a staggered arrangement. In this respect, the distance between the rows can also be different.

In the embodiment of the solution according to the invention with a continuously operating conveyor device, it is sufficient if at least the distressing bodies of a row are arranged in such a way that their defined areas cover the total width of the blocks passing underneath the distressing bodies.

In principle, just one row of distressing bodies or a few rows of distressing bodies can be sufficient to age the blocks. However, as has been shown in practice, this does not result in an optimum ageing pattern and also means that the throughput speed is relatively low. It is advantageous if at least 20 rows of distressing bodies are provided, preferably a maximum of 40 rows.

In one embodiment of the solution according to the invention, in which no continuously operating conveying device is provided, it can be provided that the distressing bodies are fastened in such a way that the defined areas of the individual distressing bodies together cover at least the entire surface-preferably of the blocks fed in layers.

With discontinuous ageing, the blocks are fed to the area in which they are to be aged in layers or as a unit and aged in a single operation, i.e. the blocks are only transported onwards when ageing is complete.

In a variation of discontinuous ageing, several ageing stations can also be provided, to which the blocks are fed one after the other, wherein the blocks are aged in the desired manner after they have passed through all the ageing stations.

In contrast to discontinuous ageing, continuous ageing provides for the blocks to be transported permanently in the feed direction, i.e., a layer or unit of blocks is not fed specifically to the ageing station(s), but rather it is a continuous process. This is also possible by feeding the blocks at intervals. The vibration process does not have to be interrupted for this. The blocks are left in position for a relatively short period of time, e.g., 3 to 15 seconds, preferably 5 seconds (no feed) and then transported a little further. In tests, this has resulted in an advantageous ageing pattern without a system-related accumulation.

It is advantageous if the distressing bodies are arranged at a distance above the blocks when at rest. This allows the blocks to be transported underneath the distressing bodies without scratching. A distance between the blocks and the distressing bodies is possible without any problems, especially with thick blocks, as these can be aged with a high amplitude and are therefore pushed up accordingly.

However, it is also possible for the distressing bodies to rest on the surface when not in use, so that a gap does not have to be overcome first.

One, two or more vibration units, in particular unbalance generators, can be provided to vibrate the underlying surface on which the blocks rest. Reference is also made to EP 1 893 391 B1 and DE 20 2004 020 206.

Features which have been described in conjunction with one of the objects of the invention, namely given by the method according to the invention and the apparatus according to the invention, can also be advantageously implemented for the other objects of the invention, this also applies in particular to the second and third inventions. Similarly, advantages mentioned in connection with one of the subjects of the invention can also be understood in relation to the other subjects of the invention.

It should be noted that designations such as “first” or “second” etc. are used primarily for reasons of differentiation of respective apparatus or method features and are not necessarily intended to imply that features are mutually dependent or related to each other.

In the following, embodiments of the invention are described in more detail with reference to the drawing.

The figures each show preferred embodiments in which individual features of the present invention are shown in combination with one another. Features of an exemplary embodiment can also be implemented separately from the other features of the same exemplary embodiment and can accordingly be readily combined by a person skilled in the art to form further useful combinations and sub-combinations with features of other exemplary embodiments.

In the figures, elements with the same function are marked with the same reference signs.

In the figures:

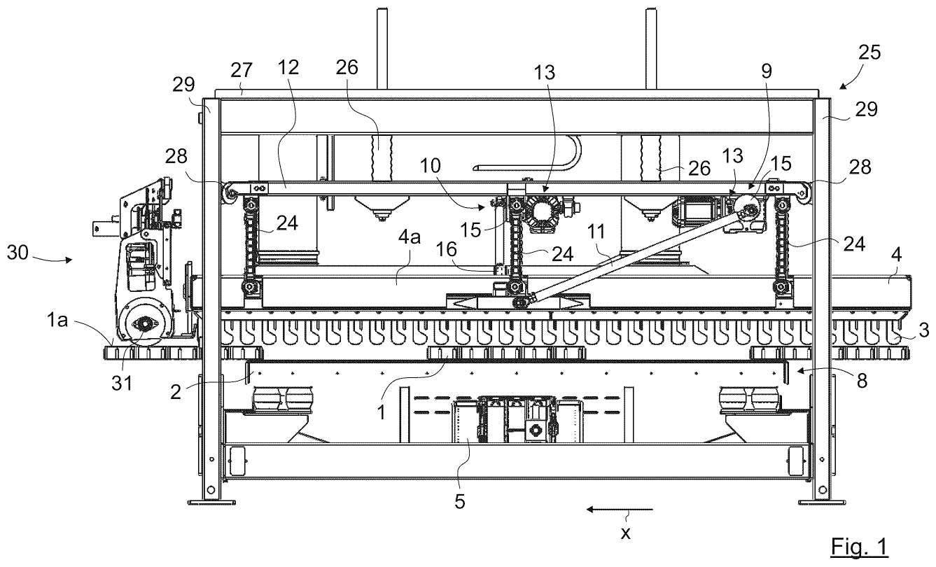

FIG. 1 shows a view of a longitudinal side of the apparatus according to the invention;

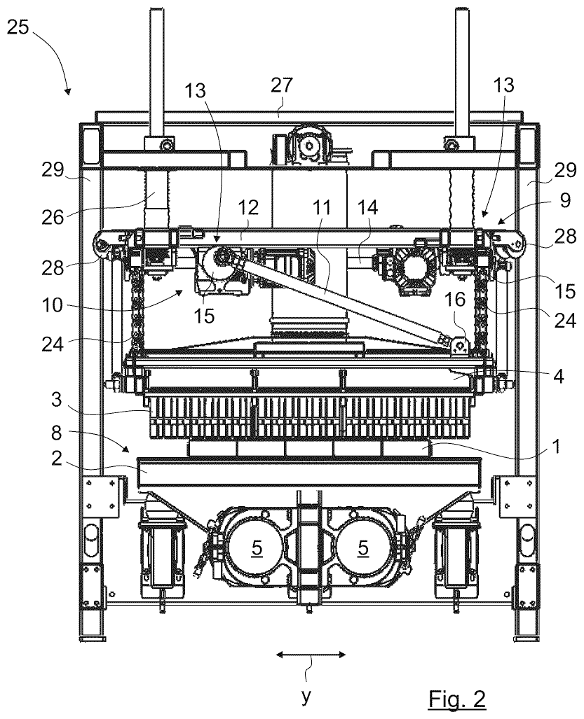

FIG. 2 shows a view of a transverse side or a view from the rear in the throughput direction of the apparatus according to the invention as shown in FIG. 1;

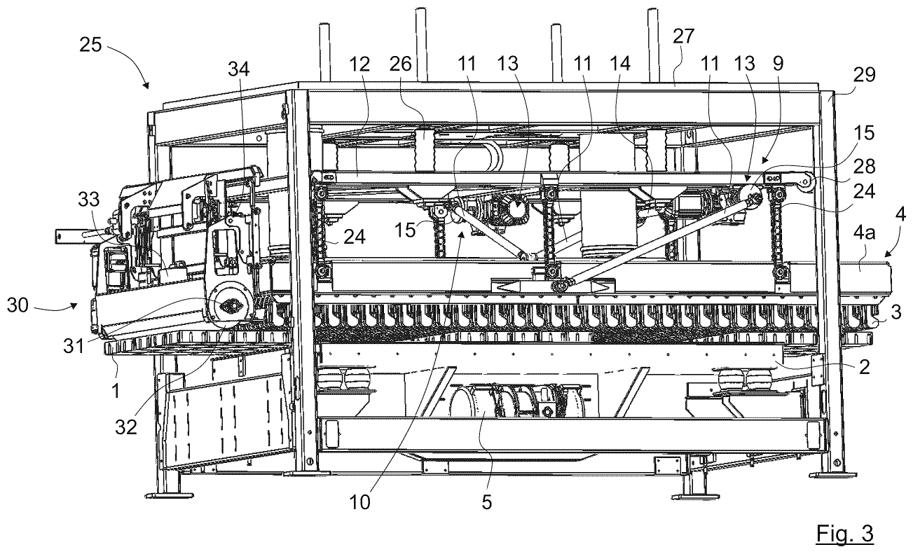

FIG. 3 shows a perspective view of the apparatus according to the invention as shown in FIG. 1;

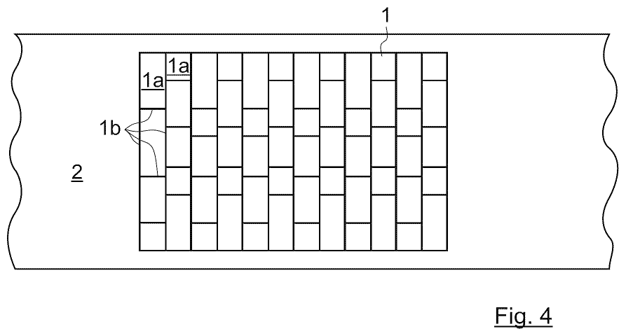

FIG. 4 shows an exemplary top view of a production layer of blocks, which are placed on an underlying surface and fed into an ageing area by means of a conveyor, without a representation of the distressing bodies arranged above;

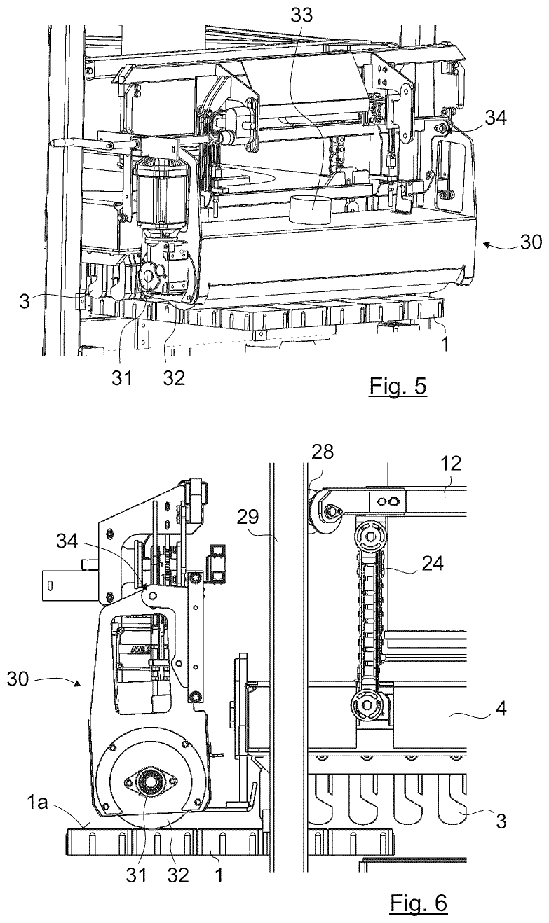

FIG. 5 shows a perspective view of an end of the apparatus according to the invention with a brushing device lying at the front in the feed direction of the blocks;

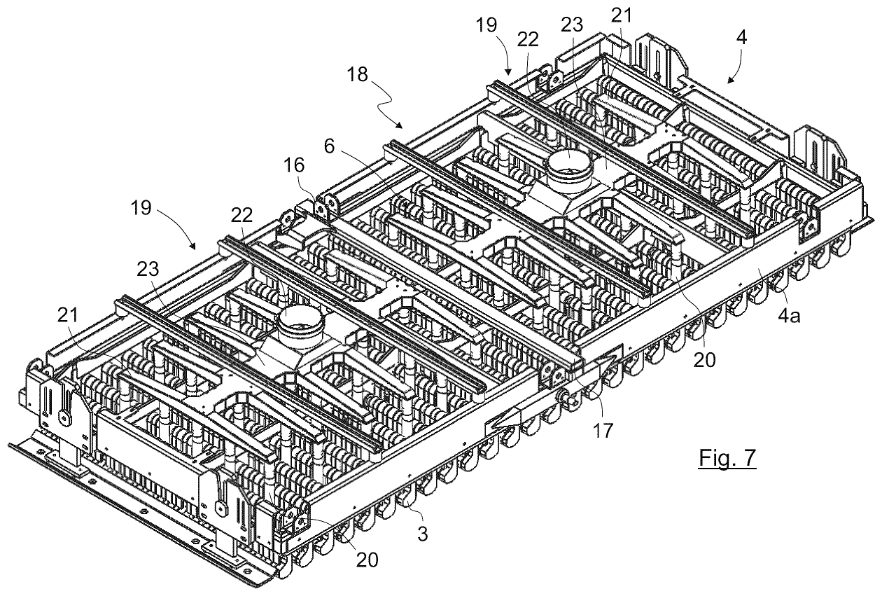

FIG. 6 shows an enlarged view of the brushing device as shown in FIG. 1;

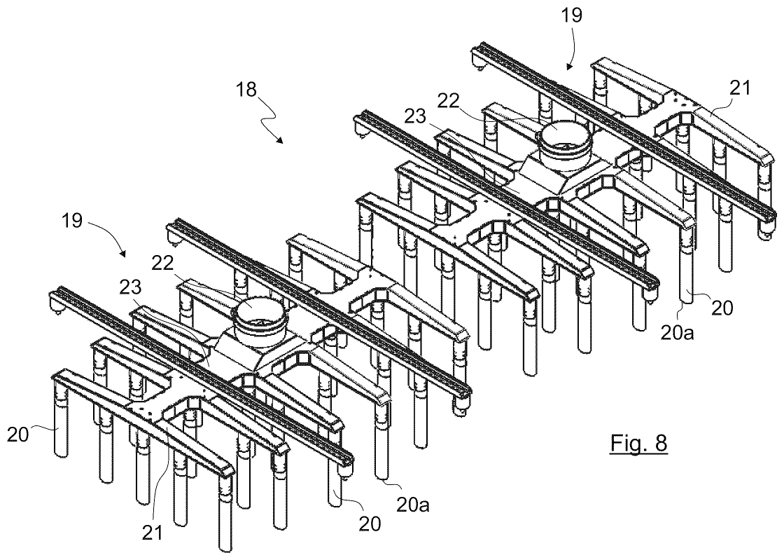

FIG. 7 shows a perspective view of a retaining device and a suction device;

FIG. 8 A single illustration of the suction device shown in FIG. 6 with two suction units;

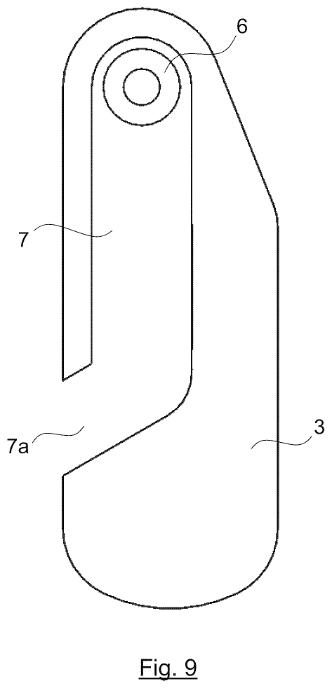

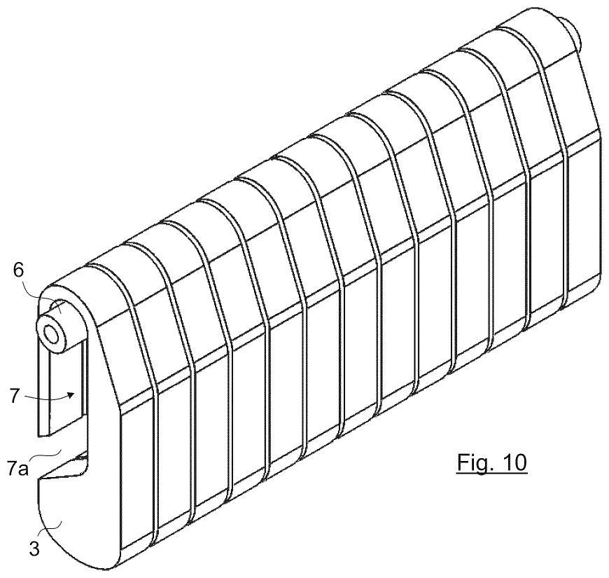

FIG. 9 a side view of a particularly advantageous distressing body; and

FIG. 10 an exemplary arrangement of a row of distressing bodies on a retaining element of the retaining device designed as a retaining rod.

According to the invention, any blocks, for example covering elements, façade elements, sand-lime blocks, concrete blocks, bricks or vitrified bricks or natural stones can be aged regardless of their material properties. In the following, the ageing of blocks 1, which are designed as concrete blocks, is explained with reference to the exemplary embodiments. However, the invention is of course not limited to this.

The production of concrete blocks 1, in particular concrete paving blocks, is well known, which is why it will not be discussed in more detail below. The concrete blocks 1 generally leave the production plant in a production layer, i.e., in an arrangement in which a large number of concrete blocks 1 are arranged next to each other in a single layer. Such production layers are shown by way of example in FIGS. 1 to 4.

As can be seen in FIGS. 1 to 4, the concrete blocks 1 are applied in a single layer in a regular arrangement on an underlying surface 2. The concrete blocks 1 are arranged in such a way that the edge 1b or the surface 1a to be worked (=usually the later visible side) of the block 1 is on top.

With regard to the general principle of ageing with distressing bodies 3, reference is made to DE 20 2004 020 206 and EP 1 893 391B1.

As can be seen from the figures, the surfaces 1a and the edges 1b of the blocks 1 adjacent to the surfaces 1a are worked by distressing bodies 3, which are movable within a defined range relative to the surface 1a of the blocks 1. For this purpose, the distressing bodies 3 are movably attached or arranged or suspended on a retaining device 4 mounted above the underlying surface 2.

As can be seen from FIGS. 1 to 3, a vibration device 5 is provided underneath the underlying surface 2 in order to set the blocks 1 and the distressing bodies 3 in motion in relation to one another in such a way that the distressing bodies 3 act on the surfaces 1a and the exposed edges 1b of the blocks 1. The vibration device 5, which can consist of several unbalance generators, for example, transmits the vibration movement directly or via other elements to the underlying surface 2 and acts from there on the blocks 1 and the distressing bodies 3. The underlying surface 2 can also represent the upper side of the vibration device 5, for example a vibration table. However, the underlying surface 2 can also be a conveyor belt on which the blocks 1 are placed. Reference is made to DE 20 2004 020 206 and EP 1 893 391 B1 with regard to advantageous embodiments in this regard and the initiation of the vibration movement.

In the exemplary embodiment, two vibration units 5 or two unbalance generators are provided.

As can be seen from the figures, the distressing bodies 3 can be moved both-within a defined range-in relation to the surface 1a of the blocks 1 and in relation to each other.

The distressing bodies 3 can be made of any material. In the exemplary embodiment, it is envisaged that the distressing bodies 3 are made of hard metal, metal or steel. The shape of the distressing bodies 3 can also be chosen as desired, wherein it has proven advantageous to make the distressing bodies 3 spherical, ring-shaped, polygonal, cylindrical or disc-shaped.

FIGS. 9 and 10 show a particularly advantageous embodiment of the distressing body 3.

It has proven to be advantageous if the lower end of the distressing body 3 facing the blocks 1 has a radius or is rounded when viewed in the feed direction of the blocks 1, in particular as shown in FIG. 9.

As can be seen from a combined view of FIGS. 1 to 3 and FIG. 7, the retaining device 4 extends plane-parallel to the surface 1a of the blocks 1 or plane-parallel to the underlying surface 2. The retaining device 4 has a plurality of retaining elements 6, each of which extends over the entire width of the blocks 1 to be aged, i.e., transversely to the direction of advance of the blocks 1.

In the exemplary embodiment, the retaining elements 6 are designed as retaining rods with a preferably circular cross-section. Particularly preferably, the retaining rods 6 are designed as tubes, as shown in FIG. 9 and FIG. 10.

In the exemplary embodiment, it is provided that each distressing body 3 is individually suspended from a retaining rod 6. The distressing bodies 3 preferably have a length, i.e., an extension from the retaining rods 6 in the direction of the surface 1a of the blocks 1, which is preferably 10 cm to 40 cm, in particular 15 cm to 35 cm. The width of the distressing bodies 3 is preferably less than 50%, preferably less than 40%, of the length of the distressing bodies 3.

As shown in FIGS. 9 and 10, the distressing bodies 3 are preferably designed in such a way that they can be hooked onto the retaining rods 6. The distressing bodies 3 have a recess 7 for this purpose. The recess 7 extends from an upper end of the distressing body 3 in the longitudinal direction to a lower end facing the blocks 1 to be worked, wherein the recess 7 extends over at least 50% of the length of the distressing body 3. The recess 7 has an access opening 7a in the area of the lower third of a rear side of the distressing body 3 in order to insert the retaining rod 6.

The rear side of the distressing body 3 is the side of the distressing body 3 that is oriented to the rear in the direction of feed of the blocks 1, i.e., facing the area in which the blocks 1 are inserted into the apparatus.

In the exemplary embodiment, it is provided that the distressing bodies 3 are arranged in such a way that the distressing bodies 3 do not touch the surface 1a of the blocks 1 to be worked when at rest.

In the exemplary embodiment, it is provided that the blocks 1 are conveyed by means of a conveying device 8 underneath the distressing bodies 3, i.e., pass through the actual ageing area. A large number of different conveying devices 8 are known from the general prior art. For example, it can be a belt, belt or chain conveyor or the like. In the exemplary embodiment, the conveyor device 8 is preferably designed as a conveyor belt, which conveys the blocks 1 over the underlying surface 2, i.e., in the actual ageing area, directly over the vibrating table. In the exemplary embodiment, it is provided that the conveyor device 8 preferably pushes the blocks 1 continuously underneath the distressing bodies 3. The throughput speed can be determined in conjunction with the overall production speed or the ageing result to be achieved.

It is also possible that the conveyor 8 merely pushes the blocks 1 to be aged, for example an entire production layer, into the intended position and that the blocks 1 are not pushed forward during the ageing process (discontinuous conveying).

A particularly suitable design of the conveyor device 8 as a chain conveyor is shown in EP 1 893 391B1, to which reference is hereby made.

A cycle time of 9 to 15 seconds for ageing the blocks 1 has proven to be particularly suitable. This means that the distressing bodies 3 act on a block 1 for 9 to 15 seconds at a time.

In the figures, the blocks are shown in a non-vibrating state for reasons of clarity. The vibration induced by the vibration device 5 causes the blocks 1 and the distressing bodies 3 to strike each other during ageing operation.

The apparatus and method according to the invention are also suitable for ageing split or cleaved blocks, which generally have an uneven surface or a surface with elevations and depressions. The split surface of the block faces the distressing bodies 3 with its fracture surface.

As shown in the exemplary embodiment, the apparatus according to the invention has a first oscillation device 9 and a second oscillation device 10. The oscillation devices 9, 10 can each have at least one push rod 11, one end of which is connected to the retaining device 4 and the other end of which is fixed to a suspension device 12 arranged above the retaining device 4.

The first oscillation device 9 causes a first oscillating movement of the retaining device 4 along a first oscillation axis.

The second oscillation device 10 causes a second oscillating movement of the retaining device 4 along a second oscillation axis. The first and second oscillation axes run at an angle of 90° to each other.

At least one of the two oscillation devices 9, 10 acts on the retaining device 4 in such a way that the retaining device 4 is also alternately removed from the surface 1a of the blocks 1 and brought closer again.

In the exemplary embodiment, both oscillation devices 9, 10 act on the retaining device 4 in such a way that it is alternately removed from the surface 1a of the blocks 1 and brought closer again.

The first and second oscillation devices 9, 10 cause the retaining device 4 to oscillate in the feed direction of the blocks 1 and transversely to the feed direction of the blocks 1 while the distressing bodies 3 are acting on the blocks 1 and, in addition, to be alternately removed from the surface 1a of the blocks 1 and brought closer again.

The first oscillation axis extends parallel to the feed direction of the blocks 1 through the apparatus according to the invention or the ageing area. The second oscillation axis extends transversely to the feed direction of the blocks 1 through the apparatus or through the ageing area.

In FIG. 1, the feed direction of the blocks 1 is indicated by the arrow x as an example. In FIG. 2, a di-rection transverse to the feed direction is shown with the double arrow y.

The first oscillation axis extends parallel to the feed direction, which is indicated by the arrow x in FIG. 1. Furthermore, the longitudinal axis of the apparatus and the longitudinal axis of the retaining device 4 also extend parallel to the direction of the arrow x in FIG. 1.

The second oscillation axis runs orthogonally to the direction of feed of the blocks 1 and parallel to the plane in which the distressing bodies 3 or the blocks 1 to be aged are arranged. This means that the second oscillation axis runs parallel to the double arrow y in the exemplary embodiment. Furthermore, the transverse axis of the apparatus or the transverse axis of the retaining device 4 also runs parallel to the double arrow y shown in FIG. 2. The double arrow y also indicates the width direction of the apparatus.

The first oscillating movement of the retaining device 4 causes the retaining device 4 to move back and forth along the first oscillation axis. The second oscillating movement of the retaining device 4 causes the retaining device 4 to move back and forth along the second oscillation axis.

The first oscillation axis and the second oscillation axis substantially run in a plane that is parallel to the plane in which the distressing bodies 3 are arranged.

The push rods 11 of the first oscillation device 9 and the push rod 11 of the second oscillation device 10 are each fixed eccentrically to drive devices 13. The drive devices 13 are part of the suspension device 12 and are preferably detachably connected to it.

In the exemplary embodiment, it is preferably provided that the push rods 11 are connected to the retaining device 4 via a joint. Preferably, the end of the push rods 11, which is fixed to the drive unit 13, is also provided with a joint so that oscillation of the retaining device 4 does not damage the push rod 11 or the drive unit 13.

The first oscillation device 9 has two push rods 11, each of which is fixed eccentrically to a common rotating drive device 13.

In the first oscillation device 9, it is provided that a rotatable shaft 14 of the drive device 13 extends transversely to the feed direction of the blocks 1, wherein a control disk 15 is fixed at each end of the shaft 14 of the drive device 13, to which one of the two push rods 11 of the first oscillation device 9 is eccentrically fixed.

It is envisaged that the end of the push rod 11 provided for transmitting the first oscillating movement, which is connected to the retaining device 4, is fixed to a longitudinal side 4a of the retaining device 4. In the exemplary embodiment, it is provided that the end is preferably fixed centrally on the longitudinal side 4a of the retaining device 4, relative to the longitudinal axis of the longitudinal side 4a.

As shown in the exemplary embodiment, it may be provided that the longitudinal side 4a is formed in several parts. In the exemplary embodiment, as can be seen, for example, from FIG. 7, it is provided that the longitudinal side 4a of the retaining device 4 is substantially formed in three parts, wherein it is provided that two comparatively long basic elements are provided at the beginning and at the end of the longitudinal side 4a, which are connected to one another via a connecting piece, which is also part of the longitudinal side 4a. A receptacle is provided on the connecting piece, to which one end of the push rod 11 can be fixed.

In the exemplary embodiment, it is provided that the second oscillation device 10 has only one push rod 11. The push rod 11 extends transversely to the feed direction of the blocks 1. The end of the push rod 11 connected to the retaining device 4 is fixed to a fastening element 16 of the retaining device 4, which is located above a position at which the push rods 11 of the first oscillation device 9 are fixed to the retaining device 4.

In the exemplary embodiment, as can be seen in particular from FIG. 7, it is provided that the two intermediate pieces of the longitudinal side 4a are connected to one another by a cross strut 17, which runs transversely to the feed direction of the blocks 1. The fastening element 16 for connecting the push rod 11 of the second oscillation device 10 is formed on this cross strut 17.

In the exemplary embodiment, it is provided that a plurality of distressing bodies 3 are suspended from each of the retaining rods 6, so that several rows of distressing bodies 3 are formed by suspending them from the retaining rods 6. An exemplary row of distressing bodies 3 is shown in FIG. 10.

Furthermore, FIG. 7 shows a particularly preferred design of the retaining device with the retaining rods 6 and the rows of distressing bodies 3 suspended from them.

As can also be seen in FIG. 7 and also, for example, in FIG. 1, gaps are formed in front of and behind a row of distressing bodies 3 or in front of and behind the retaining rods 6.

In the exemplary embodiment, a suction device 18 is provided, which has at least one suction unit 19. In the exemplary embodiment, as shown in FIGS. 7 and 8, two suction units 19 are provided. The suction units 19 each have several suction elements 20, which are positioned in spaces between the distressing bodies 3. As can be seen from a combined view of FIGS. 7 and 8, the suction elements 20 are positioned in intermediate spaces located in front of and/or behind the rows of distressing bodies 3 in the feed direction of the blocks 1. To achieve this, the suction units 19 preferably have, as shown in FIGS. 7 and 8, a plurality of suction arms 21 which extend parallel to the support rods 6 and to each of which a plurality of the suction elements 20 are connected. The suction elements 20 extend, starting from the respective suction arm 21, at least into part of the spaces between the rows of distressing bodies 3. The suction elements 20 are thus located between two adjacent rows of distressing bodies arranged on the support rods 6.

As can be seen from FIGS. 7 and 8, it is preferable if suction elements 20 are not arranged in each of the spaces between two adjacent rows of distressing bodies 3. It is sufficient if suction elements 20 protrude into every second intermediate space between two rows of distressing bodies 3.

In the exemplary embodiment, it is shown that the suction units 19 have suction arms 21, on each of which a plurality of suction elements 20 are arranged, wherein the suction elements 20 of each suction arm 21 form a row.

The suction elements 20 are preferably designed and positioned in such a way that their suction opening 20a is aligned in the direction of the surface 1a of the blocks 1.

In the exemplary embodiment, the suction elements 20 are designed as suction trunks.

In the exemplary embodiment, it is provided that a row of suction arms 21 is positioned substantially in every second intermediate space between two rows of distressing bodies 3.

As can be seen from the exemplary embodiment, it can be provided that each suction unit 19 preferably has six suction arms 21. Four to eight suction arms 21 have also proven to be advantageous. Thus, a total of twelve suction arms 21 are preferably provided for the suction unit 18. Eight to sixteen suction arms 21 have also proven to be suitable here. In the exemplary embodiment, twenty-eight rows of distressing bodies 3 are preferably provided, twenty-two to thirty-six rows of distressing bodies 3 are also suitable here. The eight to sixteen, in particular the twelve, suction arms 21 are positioned in such a way that they penetrate into or are positioned in a corresponding number of spaces between the rows of distressing bodies 3.

The suction units 19 preferably each have a central suction nozzle 22, to which the suction arms 21 are preferably connected by means of a central supply channel 23, which extends in the feed direction of the blocks 1.

As can also be seen from FIGS. 1 to 3 and FIG. 6, the retaining device 4 is suspended from the suspension device 12 by a plurality of flexible suspension elements 24. In the exemplary embodiment, four to eight, preferably six, flexible suspension elements 24 are provided. In the exemplary embodiment, the flexible suspension elements are designed as chains 24.

In the exemplary embodiment, the suspension device 12 is height-adjustable relative to a support frame 25 of the apparatus.

In the exemplary embodiment, at least two, preferably three to eight, in particular four, height adjustment units 26 are provided, which connect the suspension device 12 to an upper frame part 27 of the support frame 25 present above the suspension device 12 in such a way that the suspension device 12 can be adjusted in height by the height adjustment units 26.

In the exemplary embodiment, the height adjustment units 26 are designed as spindle drives.

The suspension device 12 has guide elements 28 that rest against vertical frame parts 29 of the support frame 25 in order to guide the suspension device 12 during height adjustment. In the exemplary embodiment, the guide elements 28 are designed as guide rollers.

As can be seen from FIGS. 1, 3, 5 and 6, the apparatus shown in the exemplary embodiment preferably has a brushing device 30 which extends transversely to the feed direction of the blocks 1 and which is positioned in such a way that the blocks 1 pass through the brushing device 30 after the action of the distressing bodies 3, i.e., after the ageing process has ended.

In the exemplary embodiment, the brushing device 30 is arranged at the exit of the ageing area, i.e., at the end of the apparatus according to the invention which is at the front in the feed direction of the blocks 1. The brushing device 30 extends over a width which corresponds at least to the width of the blocks 1 to be aged, in particular the width of a production layer or the extension of a row of blocks 1 (viewed transversely to the feed direction of the blocks 1). This is shown accordingly in FIG. 3 and FIG. 5.

The brushing device 30 has a brush 32 rotating about a longitudinal axis 31. The longitudinal axis 31 of the brush 32 extends transversely to the feed direction of the blocks 1. In the exemplary embodiment, it is provided that the brush 32 is height-adjustable. The brush 32 is arranged in the working position in such a way that the brush 32 brushes the surface 1a of the blocks 1.

In the exemplary embodiment, the brush 32 is designed as a roller.

The brush 32 can be designed in such a way that it cleans and/or smooths and/or produces a surface shine.

In the exemplary embodiment, the brush 32 can in particular also be designed as a dirt brush.

The brushing device 30 can optionally also have a suction unit 33.

In the exemplary embodiment, it is provided that the brushing device 30 has a swivel-out device 34. The swivel-out device 34 enables the brushing device 30 to swivel away. This is particularly advantageous if one of the blocks 1 has become dislodged. In a particularly advantageous embodiment, it is provided that the brushing device 30 includes an emergency shut-off which stops the entire apparatus if the swing-out device 34 has been swung out beyond a certain extent, in particular by a block.

What is claimed is:

1. An apparatus for the artificial ageing of blocks, in particular concrete blocks, vitrified bricks and natural stones, comprising:
an underlying surface, on which the blocks can be placed in such a way that their surface to be worked and the adjoining edges are exposed;
a retaining device arranged above the underlying surface and having a plurality of retaining elements, on which distressing bodies are movably fastened for working the surfaces and the adjacent edges of the blocks, in such a way that the fastening allows a movement of the distressing bodies within a defined range relative to the surface of the blocks;
a vibration device to make the underlying surface on which the blocks are resting vibrate in order for the blocks resting on the underlying surface and the distressing bodies to be set in motion in relation to one another in such a way that the distressing bodies act on the surface and the adjacent edges of the blocks; and
at least one first oscillation device and one second oscillation device, wherein the oscillation devices each have at least one push rod, one end of which is connected to the retaining device and the other end of which is fixed to a suspension device arranged above the retaining device, wherein the first oscillation device effects a first oscillating movement of the retaining device along a first oscillation axis and the second oscillation device effects a second oscillating movement of the retaining device along a second oscillation axis, wherein the oscillation axes run at an angle of 90° to one another, and wherein at least one of the first or second oscillation devices additionally alternately moves the retaining device away from the surface of the blocks and brings it closer again.

2. The apparatus as claimed in claim 1, wherein the first oscillation axis and the second oscillation axis substantially run in a plane that is plane-parallel to the plane in which the distressing bodies are arranged.

3. The apparatus as claimed in claim 1, wherein the push rod of the first oscillation device and/or the push rod of the second oscillation device is fixed eccentrically to a drive device of the suspension device.

4. The apparatus as claimed in claim 1, wherein the first oscillation device has two push rods, each of which is fixed eccentrically to a common drive device.

5. The apparatus as claimed in claim 4, wherein a shaft of the drive device extends transversely to the feed direction of the blocks, wherein a control disk is fixed at each end of the shaft of the drive device, to which control disk one of the two push rods is eccentrically fixed.

6. The apparatus as claimed in claim 1, wherein the end, connected to the retaining device, of the push rod provided for transmitting the first oscillating movement is fixed to a longitudinal side of the retaining device, preferably centrally on the longitudinal side of the retaining device with respect to the longitudinal axis of the longitudinal side.

7. The apparatus as claimed in one of claim 1, wherein the second oscillation device has a push rod which extends transversely to the feed direction of the blocks, wherein the end of the push rod connected to the retaining device is fixed to a fastening element of the retaining device, which is located above a position at which the push rod or the push rods of the first oscillation device are fixed to the retaining device.

8. The apparatus as claimed in claim 1, wherein the retaining elements are designed as retaining rods, which are arranged one behind the other in the direction of advance of the blocks and each extend transversely to the direction of advance of the blocks, wherein a plurality of distressing bodies are arranged, preferably suspended, on each retaining rod.

9. The apparatus as claimed in one of claim 1, wherein a suction device is provided, which has at least one suction unit with a plurality of suction elements, which are positioned in intermediate spaces between the distressing bodies, in particular in intermediate spaces which are located in front of and/or behind the distressing bodies in the direction of advance of the blocks.

10. The apparatus as claimed in claim 8, wherein the suction unit has a plurality of suction arms which extend parallel to the retaining rods and to each of which a plurality of the suction elements are connected, wherein the suction elements extend from the respective suction arm into at least part of the intermediate spaces which are formed between two adjacent rows of distressing bodies arranged respectively on the retaining rods.

11. The apparatus as claimed in claim 10, wherein each of the suction units has three to nine, suction arms, and wherein a central suction nozzle is provided, to which the suction arms are connected, preferably by means of a central supply duct extending in the direction of advance of the blocks.

12. The apparatus as claimed in claim 1, wherein the retaining device is suspended from the suspension device by a plurality of flexible suspension elements.

13. The apparatus as claimed in claim 12, wherein the retaining device is suspended from the suspension device with the aid of at least four, flexible suspension elements.

14. The apparatus as claimed in claim 12, wherein the flexible suspension elements are chains, ropes or straps.

15. The apparatus as claimed in claim 1, wherein the suspension device is height-adjustable relative to a supporting frame of the apparatus.

16. The apparatus as claimed in claim 15, wherein at least two, height adjustment units are provided, which connect the suspension device to an upper frame part of the supporting frame present above the suspension device in such a way that the suspension device can be adjusted in height by the height adjustment units, wherein the suspension device has guide elements, in particular guide rollers, which bear against vertical frame parts of the support frame in order to guide the suspension device during the height adjustment.

17. The apparatus as claimed in claim 1, wherein a brushing device is provided, which extends transversely to the feed direction of the blocks and which is positioned in such a way that the blocks pass through the brushing device after the action of the distressing bodies.

18. The apparatus as claimed in claim 17, wherein the brushing device has a brush rotating about a longitudinal axis, wherein the longitudinal axis of the brush extends transversely to the feed direction of the blocks, wherein the brush is height-adjustable and arranged in such a way that the brush brushes off the surface of the blocks.

19. The apparatus as claimed in claim 17, wherein the brushing device has a suction unit.

20. The apparatus as claimed in one of claim 1, wherein the distressing bodies have a recess in order to suspend them from the retaining elements, in particular the retaining rods, wherein the recess extends from an upper end of the distressing body in the longitudinal direction to a lower end facing the blocks to be worked, wherein the recess extends over at least 50% of the length of the distressing body and wherein the recess has an access opening in the region of the lower third of a rear side of the distressing body in order to insert the retaining elements, in particular the retaining rods.

21. A method for artificially ageing blocks, in particular concrete blocks, vitrified blocks and natural stones, according to which the blocks are placed on an underlying surface in such a way that the surface of the blocks to be worked and the adjacent edges are exposed, after which the surface of the blocks to be worked is brought into contact with a plurality of distressing bodies, which are each movable within a defined range relative to the surface of the blocks by means of a movable attachment to a retaining device arranged above the blocks, and after which the blocks are set in motion by a vibration of the underlying surface in such a way that the distressing bodies act on the surface and the adjacent edges of the blocks, and wherein the retaining device is oscillated in the direction of advance of the blocks and transversely to the direction of advance of the blocks while the distressing bodies act on the blocks and is also alternately removed from the surface of the blocks and brought closer again.

22. The method as claimed in claim 21, wherein the retaining device is suspended via flexible suspension elements, in particular chains, from a suspension device located above the retaining device.

23. The method as claimed in claim 22, wherein for oscillating and alternating movement of the retaining device, push rods are provided, one end of which is fixed to the retaining device and the other end of which is fixed eccentrically to control disks of drive devices, wherein the drive devices are designed as part of the suspension device.

24. The method as claimed in claim 21, wherein the dust produced by the action of the distressing bodies on the surface and the adjacent edges of the blocks is suctioned by a suction device which has a plurality of suction elements which are positioned in intermediate spaces between the distressing bodies, in particular in the intermediate spaces which are located in front of and/or behind the distressing bodies in the feed direction, and of which the suction openings are aligned in the direction of the surface of the blocks.

25. The method as claimed in one of claim 21, wherein after the distressing bodies have acted on the surface and the adjacent edges of the blocks, the surface of the blocks is brushed and/or smoothed and/or provided with a surface gloss and preferably additionally vacuumed.
